(19) United States
(12) Patent Application Publication
(10) Pub. No.: US 2026/0147090 A1
(43) Pub. Date: May 28, 2026

(54) ECHO SIGNAL PROCESSING METHOD, APPARATUS, TERMINAL DEVICE, AND COMPUTER PROGRAM PRODUCT

(71) Applicant: SUTENG INNOVATION TECHNOLOGY CO., LTD., Shenzhen (CN)

(72) Inventors: Rusong HE, Shenzhen (CN); Changsheng GONG, Shenzhen (CN)

(73) Assignee: SUTENG INNOVATION TECHNOLOGY CO., LTD., Shenzhen (CN)

(21) Appl. No.: 19/386,188

(22) Filed: Nov. 11, 2025

(30) Foreign Application Priority Data
Nov. 22, 2024 (CN) 202411691272.0

(51) Int. Cl. G01S 7/41; G01S 13/04; G01S 13/42

(52) U.S. Cl. CPC G01S 7/41; G01S 13/04; G01S 13/426

(57) ABSTRACT

An echo signal processing method, an apparatus, a terminal device, and a computer-readable storage medium for a radar system are provided. The radar system includes scanning channels, each allocated to at least two different scanning channel groups within a scanning cycle. Echo signals received multiple times by a scanning channel are superimposed to generate a superposition result. A crosstalk echo is identified based on the superposition result, for example, by determining that the number of original echoes constituting a superimposed echo is less than a number of activations of the channel, or by comparing a peak value of the superimposed echo to a crosstalk threshold. Upon identification, the crosstalk echo is filtered out to obtain a valid echo for target identification.

### CROSS-REFERENCE TO RELATED APPLICATION

The present application claims the benefit of priority to Chinese Patent Application No. 202411691272.0, filed on Nov. 22, 2024, which is hereby incorporated by reference in its entirety.

### TECHNICAL FIELD

This application belongs to the field of radar technology, and in particular, relates to an echo signal processing method, an apparatus, a terminal device, and a computer program product.

### BACKGROUND

For radars with high resolution and high frame rates, the small physical isolation between adjacent channels exacerbates the degree of crosstalk between channels. To reduce inter-channel crosstalk, transmission coding and appropriate filtering strategies can be employed to distinguish between genuine echoes and crosstalk echoes. However, due to the number of channels exceeding the number of transmission codes, concurrent channels will exist, leading to certain interference between these concurrent channels. In cases where the target object is a high-reflectivity object, more severe crosstalk will be generated.

In the presence of high-reflection crosstalk, echoes from crosstalk channels are superimposed multiple times, meaning that echoes from crosstalk channels are also superimposed onto genuine echoes. This prevents the radar system from effectively distinguishing between genuine echoes and crosstalk echoes. High-reflection crosstalk caused by high-reflectivity objects severely affects the genuine echo signals of the radar and interferes with the radar's measurement calculations. Therefore, how to perform high-reflection crosstalk filtering in scenarios involving multiple scan superimpositions to improve the measurement accuracy of the radar is an urgent problem that needs to be addressed currently.

### SUMMARY

Embodiments of the present application provide an echo signal processing method, an apparatus, a terminal device, and a computer program product. The method can distribute high-reflection crosstalk from a high-reflection channel among different scanning channels, such that only part of the echoes in the affected scanning channel are subject to crosstalk. Consequently, crosstalk echo identification can be performed based on the superposition result after overlapping, thereby enabling the filtering out of crosstalk echoes, reducing the impact of high-reflection crosstalk on radar measurement results, and thus improving the measurement accuracy of the radar.

In a first aspect, an embodiment of the present application provides an echo signal processing method, applied to a radar system. The radar system includes at least two scanning channels, where any one scanning channel is allocated to at least two scanning channel groups within one scanning cycle. The method includes:
acquiring echo signals received multiple times by a scanning channel;
superimposing the echo signals received multiple times by the scanning channel to obtain an echo superposition result of the scanning channel;
performing crosstalk echo identification based on the echo superposition result, and upon identifying the presence of a crosstalk echo, filtering out the crosstalk echo to obtain a valid echo of the scanning channel; and
performing target identification based on the valid echoes from all scanning channels.

In an implementation manner of the first aspect, said performing crosstalk echo identification based on the echo superposition result includes:
extracting echo characteristic parameters of the multiple echo signals received by the scanning channel and echo characteristic parameters of the echo superposition result; and
performing crosstalk echo identification based on the echo characteristic parameters of the multiple echo signals received by the scanning channel and the echo characteristic parameters of the echo superposition result.

In an implementation manner of the first aspect, the echo characteristic parameters include an echo peak value and a corresponding reception time of the echo; if the echo superposition result includes multiple echoes, and there is a difference in the reception times of said multiple echoes, then said performing crosstalk echo identification based on the echo characteristic parameters of the multiple echo signals received by the scanning channel and the echo characteristic parameters of the echo superposition result includes: determining, based on the echo peak values and the corresponding reception times of the respective echoes of the echo signals received by the scanning channel, and the echo peak values and the corresponding reception times of the respective echoes in the echo superposition result, the number of original echo signals corresponding to each echo in the echo superposition result; and

if the number of original echo signals corresponding to an echo in the echo superposition result is less than the number of activations of the scanning channel, determining that said echo is a crosstalk echo.

In an implementation manner of the first aspect, the echo characteristic parameters of the multiple echo signals received by the scanning channel include a maximum peak value of the multiple echo signals of the scanning channel; if the echo superposition result includes multiple echoes, and there is a difference in the reception times of said multiple echoes, then the echo characteristic parameters of the echo superposition result include the peak value and the corresponding reception time of each echo in the echo superposition result; said performing crosstalk echo identification based on the echo characteristic parameters of the multiple echo signals received by the scanning channel and the echo characteristic parameters of the echo superposition result includes:
determining a target maximum peak value corresponding to each echo based on the reception times of the multiple echoes in the echo superposition result;
calculating a crosstalk threshold corresponding to the echo based on the target maximum peak value; and
if the peak value of an echo is less than the crosstalk threshold corresponding to said echo, determining that said echo is a crosstalk echo.

In an implementation manner of the first aspect, before said acquiring echo signals received multiple times by a scanning channel, the method further includes: generating a channel grouping rule based on the number of scanning channels and a detection accuracy of the radar system; grouping the scanning channels of the radar system according to the channel grouping rule.

In an implementation manner of the first aspect, the number of scans for different scanning channel groups is equal or unequal.

In an implementation manner of the first aspect, the physical interval between scanning channels within the same scanning channel group is greater than a preset interval.

In a second aspect, an embodiment of the present application provides an echo data processing apparatus, applied to a radar system. The radar system includes at least two scanning channels, where any one scanning channel is allocated to at least two scanning channel groups within one scanning cycle. The apparatus includes:
an acquisition unit, configured to acquire echo signals received multiple times by a scanning channel;
a superposition unit, configured to superimpose the echo signals received multiple times by the scanning channel to obtain an echo superposition result of the scanning channel;
an identification and filtering unit, configured to perform crosstalk echo identification based on the echo superposition result, and upon identifying the presence of a crosstalk echo, filter out the crosstalk echo to obtain a valid echo of the scanning channel; and
a target identification unit, configured to perform target identification based on the valid echoes from all scanning channels.

In a third aspect, an embodiment of the present application provides a terminal device. The terminal device includes a processor, a memory, and a computer program stored in the memory and executable on the processor. When the processor executes the computer program, the method according to the first aspect or any optional implementation manner of the first aspect is implemented.

In a fourth aspect, an embodiment of the present application provides a computer-readable storage medium. The computer-readable storage medium stores a computer program which, when executed by a processor, causes the processor to implement the method according to the first aspect or any optional implementation manner of the first aspect.

In a fifth aspect, an embodiment of the present application provides a computer program product. When the computer program product is run on a terminal device, it causes the terminal device to execute the method according to the first aspect or any optional implementation manner of the first aspect.

Beneficial effects of the embodiments of the present application compared with the prior art are as follows.

The echo signal processing method, apparatus, terminal device, and computer program product provided by the embodiments of the present application utilize received echo data obtained through partitioned transmission and reception. Each scanning channel group includes non-overlapping subsets of scanning channels across multiple operating time instances. In the event of high-reflection crosstalk, this approach disperses the high-reflection crosstalk from a high-reflection channel among different scanning channels. Consequently, only a portion of the echoes in the affected scanning channel are subject to crosstalk. This enables the identification of crosstalk echoes based on the superposition result after overlapping, thereby allowing for the filtering out of crosstalk echoes. This reduces the impact of high-reflection crosstalk on radar measurement results and improves the measurement accuracy of the radar. Furthermore, this is achieved without the need to configure more scanning channel groups or to enhance the processing capability or bandwidth of the radar system's processing chip.

### BRIEF DESCRIPTION OF DRAWINGS

To illustrate the technical solutions in the embodiments of the present application more clearly, the following briefly describes the accompanying drawings for describing the embodiments or the prior art. Obviously, the accompanying drawings in the following description show merely some embodiments of the present application, and a person of ordinary skill in the art may still derive other drawings from these accompanying drawings without creative efforts.

FIG. 1 is a schematic structural diagram of a LiDAR according to an embodiment of the present application;

FIG. 2 is a schematic diagram illustrating a process of echo superposition;

FIG. 3 is a schematic diagram illustrating the impact of a high-reflectivity object on the reception of a scanning channel;

FIG. 4 is a schematic flowchart illustrating an implementation of an echo signal processing method provided by an embodiment of the present application;

FIG. 5 is a schematic diagram of a conventional scanning channel grouping;

FIG. 6 is an exemplary diagram of a scanning channel grouping provided by an embodiment of the present application;

FIG. 7 is a schematic diagram of a result of echo signal superposition in the echo signal processing method provided by an embodiment of the present application;

FIG. 8 is a schematic structural diagram of an echo data processing apparatus provided by an embodiment of the present application; and

FIG. 9 is a schematic structural diagram of a terminal device provided by an embodiment of the present application.

### DETAILED DESCRIPTION

In the following description, for the purpose of illustration rather than limitation, specific details such as particular system architectures and techniques are set forth to facilitate understanding of the embodiments of the present application. However, it will be apparent to those skilled in the art that the present application may be implemented in other embodiments without these specific details. In other instances, detailed descriptions of well-known systems, apparatuses, circuits, and methods are omitted so as not to obscure the description of the present application with unnecessary details.

It should be understood that the term “and/or” used in the specification and appended claims of the present application refers to any combination of one or more of the associated listed items and all possible combinations, and includes such combinations. Furthermore, in the descriptions of the specification and appended claims of the present application, the terms “first,” “second,” “third,” and the like are used solely for distinguishing descriptions and should not be construed as indicating or implying relative importance.

It should also be understood that references in the description of this application to “one embodiment,” “some embodiments,” etc., indicate that a specific feature, structure, or characteristic described in connection with the embodiment is included in one or more embodiments of this application. Thus, the phrases “in one embodiment,” “in some embodiments,” “in other embodiments,” “in yet other embodiments,” and the like, which appear at different places in this specification, do not necessarily all refer to the same embodiment, but mean “one or more, but not all, embodiments,” unless otherwise specifically emphasized. The terms “comprising,” “including,” “having,” and variations thereof all mean “including but not limited to,” unless otherwise specifically emphasized.

LiDAR (Light Detection and Ranging) is a radar system that emits laser beams to detect information such as the position and velocity of a target. In addition to measuring the distance to an object, it can also detect the reflectivity of the object for target identification. The specific working principle of LiDAR involves transmitting a detection signal toward a target. Upon reaching the target, the detection signal is reflected by the object, forming echo data. By receiving the signal reflected from the target (the echo data), the LiDAR can determine relevant information about the target, such as its distance, position, altitude, velocity, attitude, shape, and reflectivity. This enables functions including target detection, target tracking, and target identification. Here, the reflectivity of an object refers to the percentage of the total incident radiant energy that is reflected by the object. Different objects have different reflectivities, which are primarily determined by factors such as the surface characteristics of the object, the wavelength of the incident signal, and the angle of incidence.

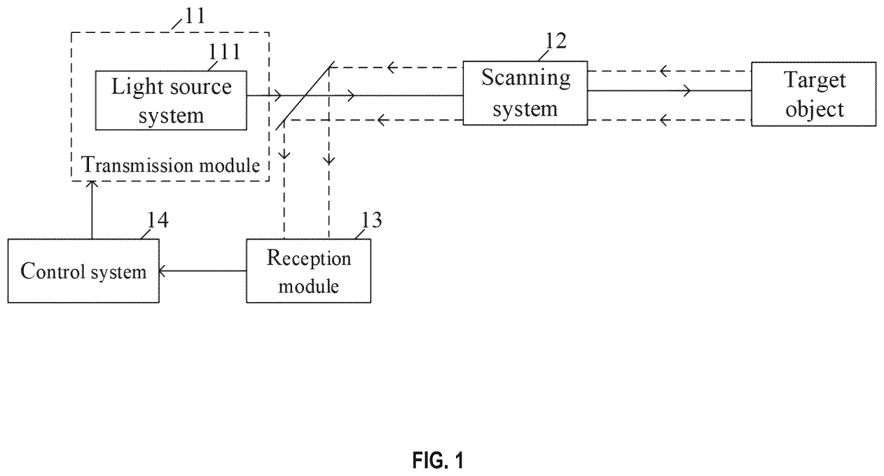

By way of example, please refer to FIG. 1, which shows a schematic structural diagram of a LiDAR. As shown in FIG. 1, LiDAR 10 typically includes a transmission module 11, a scanning system 12, a reception module 13, and a control system 14. The aforementioned transmission module 11 may include a light source system 111.

The light source system 111 is configured to generate the laser beam required for detection by the LiDAR 10. In some embodiments, the aforementioned light source system 111 may include optical components such as a laser and a transmission lens group. The aforementioned scanning system 12 is used to angularly deflect the laser beam generated by the light source system 111, enabling the laser beam to strike different positions at different times. The scanning system 12 may be a mechanical scanning system (i.e., a rotating drive platform) or a semi-solid-state scanning system (i.e., a rotating mirror, a galvanometer, or a combination thereof). The present application does not impose a unique limitation on the form of the scanning system.

It is understandable that the LiDAR in the present application may also be a solid-state LiDAR, which realizes scanning by controlling light sources at different angles to emit light sequentially. After the laser beam emitted by the light source system reaches the target object and is reflected by the target object, the reflected light pulse is received by the reception sensor 131 in the reception module 13, and then processed by the echo signal processing circuit to generate corresponding detection information.

It should be noted that the aforementioned light source system may use devices such as a Vertical Cavity Surface Emitting Laser (VCSEL) or an Edge Emitting Laser (EEL). The aforementioned sensor may be composed of a Silicon Photomultiplier (SiPM) array. A SiPM array is composed of a large number (typically ranging from hundreds to thousands) of Avalanche Photodiode (APD) units. Each APD unit consists of an avalanche photodiode and a high-resistance quenching resistor connected in series. These APD units are connected in parallel to form a surface array (i.e., the aforementioned SiPM array).

To improve the identification accuracy of LiDAR for small target objects at long distances, LiDAR systems with multiple parallel transceiver channels are typically employed for detection. Such LiDAR systems often include densely arranged multiple laser transmitters and multiple laser receivers. Consequently, the dense arrangement of both laser transmitters and laser receivers makes it difficult in the optical design of the LiDAR to avoid optical crosstalk between adjacent channels. Therefore, there is a high likelihood of crosstalk occurring between multiple adjacent channels in high-precision LiDAR systems.

Specifically, crosstalk between channels in a LiDAR system can occur due to increases in point frequency and measurement distance. Assume the effective measurement distance of the LiDAR is L, the total scanning time is Tₜₒₜ, and the total point frequency is Nₜₒₜ. The average time per point is then: Tₐᵥₑ=/ₜₒₜ/Nₜₒₜ. The time of flight for the light pulse is: τ=2L/c, where c is the speed of light. When τ<Tₐᵥₑ, only one reception channel of the LiDAR is active within each analysis time period, which can effectively avoid inter-channel crosstalk. However, as the LiDAR's point frequency increases and the measurement distance extends, Tave continuously decreases. This may lead to a situation where τ>Tₐᵥₑ. Under such conditions, multiple reception channels operate in parallel within the same time period, potentially causing crosstalk between adjacent reception channels.

Time-Correlated Single Photon Counting (TCSPC) is a commonly used method for improving the signal-to-noise ratio. It involves performing multiple transmissions and receptions for the same target within one scanning cycle, and superimposing the genuine echoes received multiple times (hereinafter referred to as multiple scan superposition).

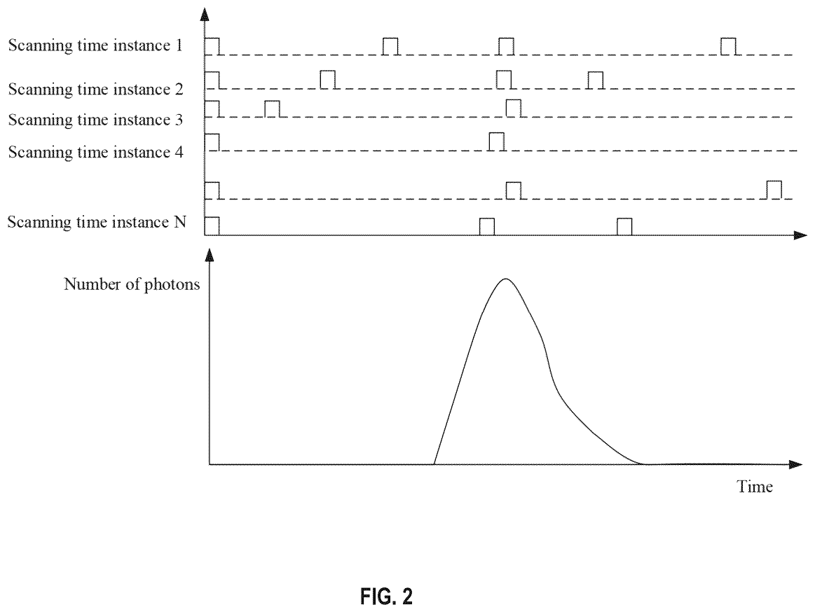

By way of example, as shown in FIG. 2, the radar system controls the radar system to perform multiple detections on the same target within one scanning cycle. After multiple transmissions, the echoes received multiple times are superimposed to obtain a final photon counting result, and the final photon counting result is used for echo analysis. Since LiDAR primarily detects the environment, the environment mainly includes two types of objects: one is Lambertian-like objects, and the other is high-reflectivity objects. Here, Lambertian-like objects refer to objects that uniformly diverge the incident laser light, achieving diffuse reflection, such as trees on the road. High-reflectivity objects refer to objects whose reflected echoes have the same direction as the incident laser and exhibit high directivity, such as road signs on the road. The echo intensity of high-reflectivity objects is more than 200 times that of Lambertian-like objects. The reflected echoes generated by high-reflectivity objects can cause severe crosstalk to the reflected echoes generated by non-high-reflectivity objects.

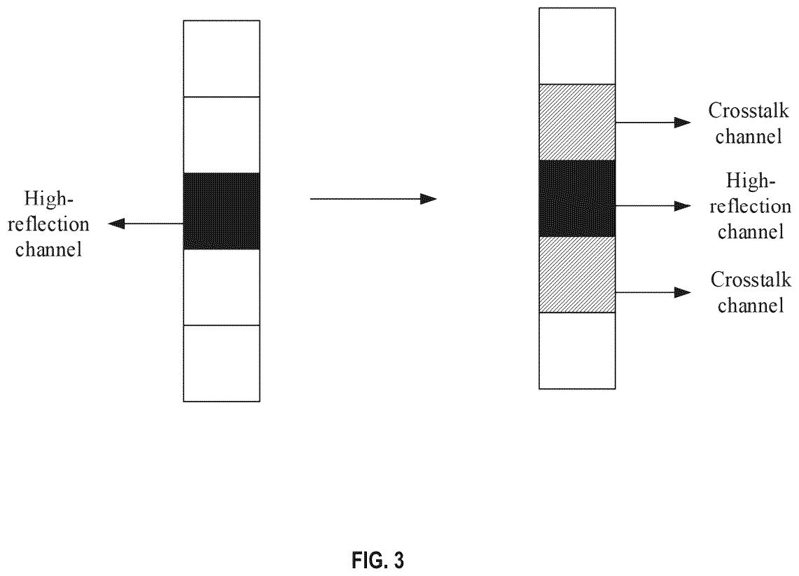

By way of example, as shown in FIG. 3, which illustrates a schematic diagram of a high-reflection crosstalk scenario, it can be observed that when multiple channels transmit and receive in parallel, if the target corresponding to one channel is a high-reflectivity object, the number of photons in the echo reflected by the high-reflectivity object will be far greater than the number of photons in the echo reflected by a non-high-reflectivity object. The echo from the high-reflection channel will cause crosstalk to the echoes of other channels, meaning high-reflection crosstalk is present.

Under conditions where high-reflection crosstalk exists, echoes from crosstalk-affected channels undergo multiple superpositions—meaning crosstalk channel echoes are also superimposed onto genuine echoes. This prevents the radar system from effectively distinguishing between genuine echoes and crosstalk echoes. High-reflection crosstalk caused by highly reflective objects severely impacts the radar's genuine echo signals and interferes with its measurement accuracy. Therefore, achieving effective high-reflection crosstalk filtering in scenarios involving multiple-scan superposition is currently an urgent problem requiring resolution.

Currently, high-reflection crosstalk is typically suppressed through time-division transmission or transmission channel encoding methods. Time-division transmission refers to reducing the number of transmission channels operating in parallel per instance and increasing the number of scanning channel groups for sequential transmission to lower concurrency. However, in high-resolution radar systems, the time available for transmission and reception is constrained, which limits the support for an excessive number of scanning channel groups operating sequentially. Consequently, the number of scanning channels operating in parallel remains relatively large, and the issue of high-reflection crosstalk affecting the measurement accuracy of the radar system persists.

Transmission channel encoding is an important means of suppressing high-reflection crosstalk. It works by adjusting the time intervals between successive transmissions from multiple transmission channels, thereby separating the valid signals and crosstalk signals in time. Since high-reflection crosstalk echoes exhibit random jitter, after superimposing the echo data obtained from multiple scans, crosstalk echoes can be filtered out based on spatiotemporal coherence analysis. However, the echo processing for transmission channel encoding is relatively complex. Furthermore, the bandwidth and processing capacity of the radar system's processing chip are limited, often insufficient to handle such a large volume of echo data. Consequently, implementing this approach necessitates using a processing chip with greater processing power and higher bandwidth to manage the extensive echo data received through transmission encoding methods, which undoubtedly increases implementation difficulty and cost.

Based on this, embodiments of the present application provide an echo signal processing method. Since the received echo data is obtained through sequential transmission by scanning channel groups, and the scanning channels included in each scanning channel group are partially non-overlapping across multiple operating time instances—meaning the same scanning channel is allocated to at least two scanning channel groups within one scanning cycle—this approach, in the event of high-reflection crosstalk, can disperse the high-reflection crosstalk from a high-reflection channel among different scanning channels. As a result, only a portion of the echoes in the affected scanning channel are subject to crosstalk. This enables the identification of crosstalk echoes based on the superposition result after overlapping, thereby allowing for the filtering out of crosstalk echoes. Target identification is then performed using only the valid echoes. This reduces the impact of high-reflection crosstalk on radar measurement results, improves the measurement accuracy of the radar, and is achieved without the need to configure more scanning channel groups or to enhance the processing capability or bandwidth of the radar system's processing chip.

The echo signal processing method provided by the embodiments of the present application will be described in detail below.

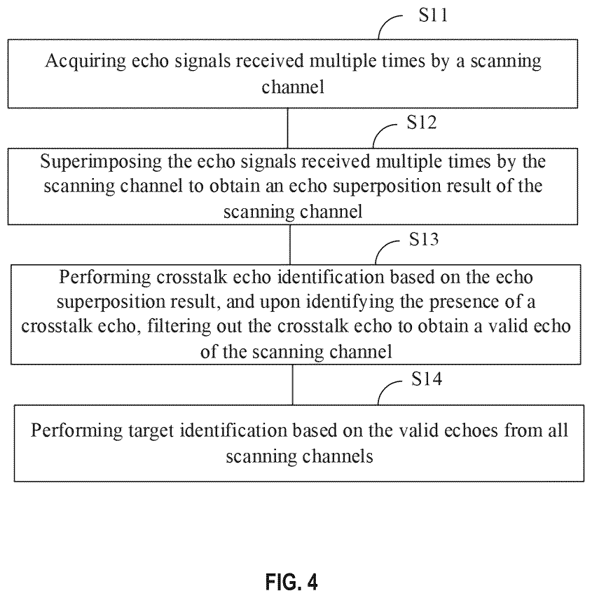

Please refer to FIG. 4, which illustrates an implementation flowchart of an echo signal processing method provided by an embodiment of the present application. As shown in FIG. 4, the aforementioned echo signal processing method may specifically include steps S11 to S12.

It should be noted that the execution entity of the echo signal processing method provided in the embodiments of the present application may be the aforementioned LiDAR 10, specifically a data processing apparatus within the LiDAR 10. Of course, the execution entity of the aforementioned echo signal processing method may also be a terminal device communicatively connected to the LiDAR 10. The terminal device may be a mobile phone, desktop computer, laptop, tablet, wearable device, or other terminal, or it may be a cloud server, radar auxiliary computer, or other equipment in various application scenarios. The present application does not impose specific limitations in this regard. The following description uses the LiDAR 10 as the execution entity for illustrative purposes:

In practical applications, the radar system involved in the embodiments of the present application includes at least two scanning channels, where any single scanning channel is allocated to at least two scanning channel groups within one scanning cycle.

In practical applications, for a radar system equipped with a scanning array, different scanning groups can transmit in parallel or sequentially. It is understandable that when different scanning groups transmit in parallel, physical isolation between the groups must be ensured to prevent crosstalk. The number of activations for scanning channels in different scanning channel groups may be the same or different. Specifically, the number of activations depends on the position of the scanning channel group and the required detection accuracy. Scanning channels in central regions typically require more activations, and higher detection accuracy demands also lead to more activations. Within the same scanning channel group, the number of activations per channel may be uniform or vary. For example, scanning channels corresponding to central regions may be activated more frequently than those in edge regions. As an illustration, the number of activations for a channel within a group is primarily determined by its field of view position relative to the overall scanning field—channels closer to the central field of view generally undergo more activations.

It should be noted that the division between the central scanning area and the edge scanning area may be determined based on practical application information such as the scanning field of view angle. This aspect will not be elaborated further in the embodiments of the present application.

It should also be noted that the number of activations of a scanning channel refers to the number of times the scanning channel performs transmission and reception.

In some embodiments, within one scanning cycle, different scanning channel groups transmit sequentially, while multiple scanning channels within the same scanning channel group transmit in parallel.

It should be noted that the scanning channels involved in the embodiments of the present application may include transmission channels and reception channels. Echo signals generated by detection signals transmitted from a transmission channel are received by a corresponding reception channel.

It is understandable that the radar system involved in the embodiments of the present application is a digital detection radar system. Specifically, the radar system is a multi-scanning-channel radar system, and each scanning cycle of the radar system includes at least two scanning channel groups. These at least two scanning channel groups perform transmission and reception sequentially.

Different from conventional time-correlated single-photon counting radar systems, each scanning channel in the radar system provided by the embodiments of the present application is allocated to at least two scanning channel groups within one scanning cycle.

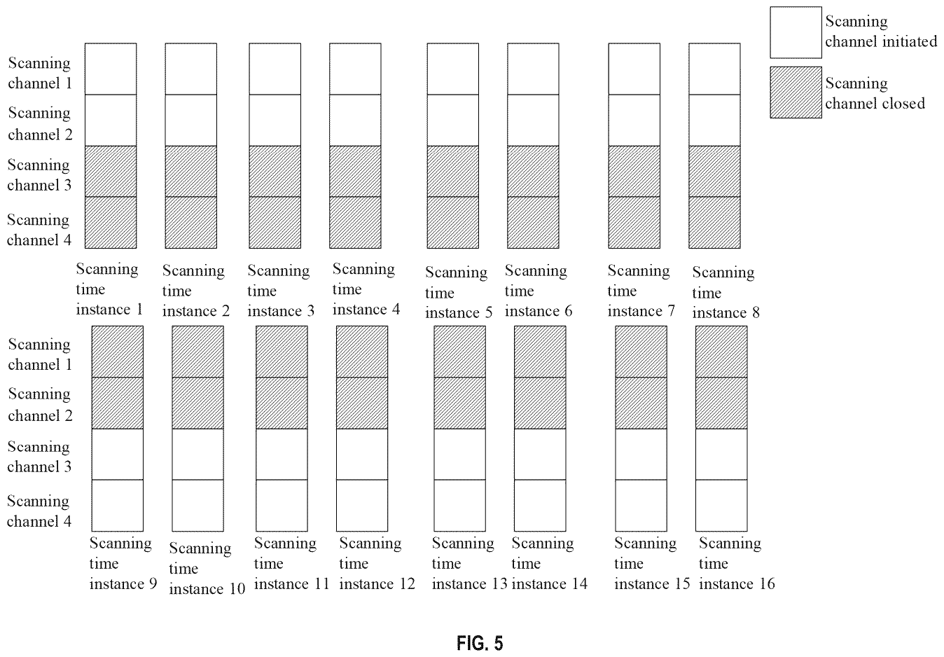

By way of example, please refer to FIG. 5, which illustrates a schematic diagram of a conventional scanning channel grouping. In conventional radar scanning when performing scanning channel grouping, each scanning channel is allocated to only one scanning channel group. Each scanning channel group can control the corresponding scanning channels within it to initiate scanning (i.e., perform transmission and reception) at the corresponding scanning time instance. As an example, as shown in FIG. 5, consider a radar system including 4 scanning channels (Channel 1, Channel 2, Channel 3, and Channel 4 as shown in FIG. 5), where a single scanning channel requires 8 superpositions. The 4 scanning channels are divided into 2 scanning channel groups (Group 1 and Group 2 as shown in FIG. 5). The radar system includes 16 scanning time instances within one scanning cycle, meaning the radar system performs transmission and reception 16 times per cycle. Each scanning channel transmits and receives 8 times. The conventional grouping method allocates scanning channel 1 and scanning channel 2 to the first scanning channel group, and scanning channel 3 and scanning channel 4 to the second scanning channel group. Scanning time instances 1-8 are the operating times for the first scanning channel group, and scanning time instances 9-16 are the operating times for the second scanning channel group. That is, scanning channels 1 and 2 in the first group are active during time instances 1-8 and inactive during time instances 9-16. Scanning channels 3 and 4 in the second group are inactive during time instances 1-8 and active during time instances 9-16.

It is understandable that if a high-reflection echo is received by scanning channel 1, and since the operating time instances of scanning channel 2 completely overlap with the scanning time instances of scanning channel 1, all echo signals received by scanning channel 2 will be affected by high-reflection crosstalk. Consequently, the radar system cannot distinguish between genuine echoes and crosstalk echoes.

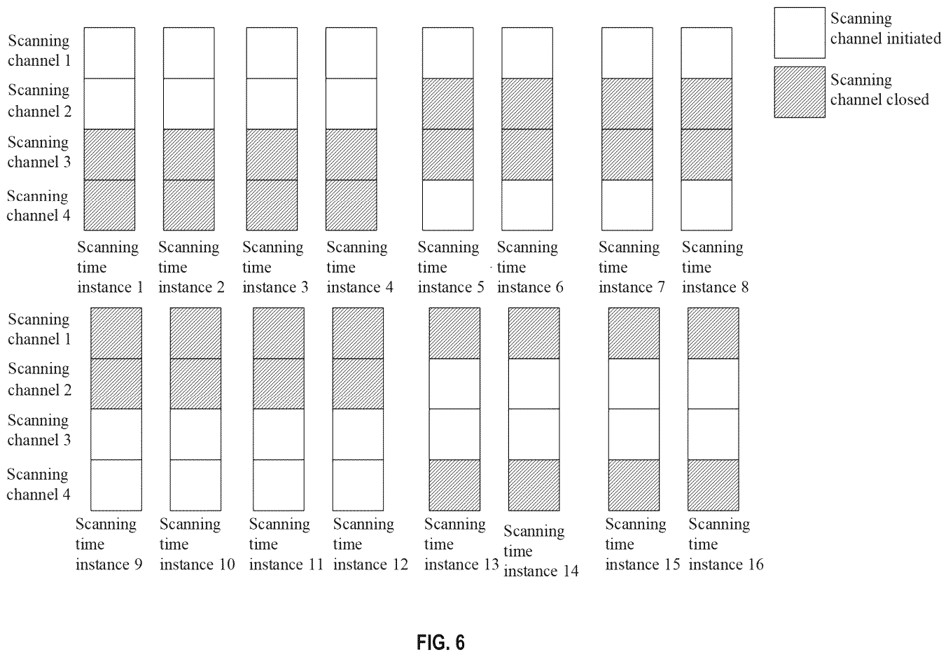

Please refer to FIG. 6, which illustrates an exemplary diagram of scanning channel grouping provided by an embodiment of the present application. In the scanning channel grouping provided by the embodiments of the present application, each scanning channel is allocated to at least two scanning channel groups. Each scanning channel group can control the corresponding scanning channels within it to initiate scanning (i.e., perform transmission and reception) at the corresponding scanning time instances. The number of scanning channel groups corresponding to each scanning channel is related to the preset scanning accuracy for that scanning channel. Specifically, a higher detection accuracy requires a greater number of groups corresponding to the scanning channel. By increasing the number of groups associated with a scanning channel, the impact of high-reflection crosstalk on parallel channels can be further mitigated, thereby enhancing the ranging accuracy.

As an example, in an embodiment of the present application, within one scanning cycle, different scanning channel groups transmit sequentially. In this embodiment, the number of activations for each scanning channel may be the same. For instance, as shown in FIG. 6, consider a radar system including 4 scanning channels (scanning channel 1, scanning channel 2, scanning channel 3, and scanning channel 4 as shown in FIG. 6), where a single scanning channel requires 8 superpositions. The radar system includes 16 scanning time instances within one scanning cycle, meaning it performs transmission and reception 16 times per cycle, with each scanning channel transmitting and receiving 8 times. In the radar system provided by this embodiment of the present application: scanning channel 1 and scanning channel 2 are allocated to scanning channel group 1. Scanning channel 1 and scanning channel 4 are allocated to scanning channel group 2. Scanning channel 3 and scanning channel 4 are allocated to scanning channel group 3. Scanning channel 2 and scanning channel 3 are allocated to scanning channel group 4. The operating time instances are as follows: scanning time instances 1-4 are the operating times for scanning channel group 1 (channels 1 and 2 are active). Scanning time instances 5-8 are the operating times for scanning channel group 2 (channels 1 and 4 are active). Scanning time instances 9-12 are the operating times for scanning channel group 3 (channels 3 and 4 are active). Scanning time instances 13-16 are the operating times for scanning channel group 4 (channels 2 and 3 are active).

Assuming that scanning channel 1 detects a high-reflectivity object, the high-reflection echo generated by scanning channel 1 will interfere with: Part of the echoes received by scanning channel 2 (specifically, echoes received when scanning channel 2 is active simultaneously with scanning channel 1), and Part of the echoes received by scanning channel 4 (specifically, echoes received when scanning channel 4 is active simultaneously with scanning channel 1). However, it will not interfere with all echoes of scanning channel 2 or all echoes of scanning channel 4. Therefore, the radar system can superimpose the echo data obtained from multiple scans of scanning channel 2 or scanning channel 4 and use the superimposed echo data to distinguish between genuine echoes and crosstalk echoes.

It should be noted that the scanning time instances in the embodiments of the present application refer to the transmission time instances of different groups. It is understandable that a scanning channel within one group may have multiple transmission time instances. For example, the transmission time instances of scanning channel group 1 may include scanning time instances 1 to 4; the transmission time instances of scanning channel group 2 may include scanning time instances 5 to 8; the transmission time instances of scanning channel group 3 may include scanning time instances 9 to 12; and the transmission time instances of scanning channel group 4 may include scanning time instances 13 to 16.

It should be noted that FIG. 6 is merely an example of the scanning channel grouping involved in the embodiments of the present application and is not limiting. The present application does not impose unique restrictions on the number of channels, the number of groups, or the number of channels in each group.

In the embodiments of the present application, the grouping of scanning channels can be configured according to practical application requirements. Parameters such as the number of scanning channels in the radar system, the number of scanning channel groups, the number of scans per scanning cycle of the radar system, and the number of scanning channels included in each scanning channel group can all be determined based on the actual application scenario. The present application does not impose specific limitations on these parameters.

By way of example, still considering the case where the radar system includes 4 scanning channels, the radar system includes 16 scanning time instances within one scanning cycle, and a single scanning channel requires 8 superpositions, the scanning channel grouping of the radar system may also be configured as follows:
during scanning time instances 1 to 4, scanning channel 1 and scanning channel 2 are allocated to scanning channel group 1;
during scanning time instances 5 to 8, scanning channel 1 and scanning channel 3 are allocated to scanning channel group 2;
during scanning time instances 9 to 12, scanning channel 3 and scanning channel 4 are allocated to scanning channel group 3; and
during scanning time instances 13 to 16, scanning channel 2 and scanning channel 4 are allocated to scanning channel group 4.
Furthermore:
   during scanning time instances 1 to 4, the scanning channels in scanning channel group 1 are controlled to activate;
   during scanning time instances 5 to 8, the scanning channels in scanning channel group 2 are controlled to activate;
   during scanning time instances 9 to 12, the scanning channels in scanning channel group 3 are controlled to activate; and
   during scanning time instances 13 to 16, the scanning channels in scanning channel group 4 are controlled to activate.

It is understandable that, in other embodiments, the number of activations of scanning channels may also differ. In the scanning channel grouping provided by the embodiments of the present application, each scanning channel may be allocated to at least two scanning channel groups. Within one scanning cycle, as an optional implementation, different scanning channel groups transmit sequentially, and the number of activations of different scanning channels may vary. For example, assume a radar system includes 9 scanning channels, and one scanning cycle includes 10 scanning time instances. The scanning channel grouping of the radar system may be configured as follows:
during scanning time instances 1-2, scanning channels 1, 2, and 3 are allocated to scanning channel group 1;
during scanning time instance 3, scanning channels 1, 6, and 9 are allocated to scanning channel group 2;
during scanning time instances 4-5, scanning channels 4, 5, and 6 are allocated to scanning channel group 3;
during scanning time instances 6-7, scanning channels 2, 4, and 7 are allocated to scanning channel group 4;
during scanning time instances 8-9, scanning channels 7, 8, and 9 are allocated to scanning channel group 5; and
during scanning time instance 10, scanning channels 3, 5, and 8 are allocated to scanning channel group 6.
Furthermore:
   during scanning time instances 1-2, the scanning channels in scanning channel group 1 are controlled to activate;
   during scanning time instance 3, the scanning channels in scanning channel group 2 are controlled to activate;
   during scanning time instances 4-5, the scanning channels in scanning channel group 3 are controlled to activate;
   during scanning time instances 6-7, the scanning channels in scanning channel group 4 are controlled to activate;
   during scanning time instances 8-9, the scanning channels in scanning channel group 5 are controlled to activate; and
   during scanning time instance 10, the scanning channels in scanning channel group 6 are controlled to activate.

In some embodiments, within one scanning cycle, scanning channel groups with larger physical intervals may also transmit in parallel. That is, different scanning channel groups can transmit in parallel within the same scanning cycle. For example, consider a radar system including 4 scanning channels, with one scanning cycle including 16 scanning time instances. In the radar system provided by this embodiment of the present application, assume that the physical interval between scanning channel 1 and scanning channel 3 is large, and the physical interval between scanning channel 4 and scanning channel 2 is large. If scanning channels 2 and 3 are allocated to scanning channel group 1, and scanning channels 1 and 4 are allocated to scanning channel group 2, then scanning channel group 1 and scanning channel group 2 can transmit in parallel. Additionally, scanning channels 3 and 4 can be allocated to scanning channel group 3, and scanning channels 3 and 2 can be allocated to scanning channel group 4. Scanning channel group 3 and scanning channel group 4 can transmit sequentially. For instance, scanning time instances 1-8 can be set as the operating time instances for scanning channel groups 1 and 2; scanning time instances 9-12 can be set as the operating time instances for scanning channel group 3; and scanning time instances 13-16 can be set as the operating time instances for scanning channel group 4.

It is understandable that the above descriptions are merely exemplary illustrations of dividing scanning channel groups according to preset partitioning rules and are not intended to be limiting.

In some embodiments, a corresponding channel grouping rule may be generated based on the number of scanning channels of the radar system and a detection accuracy, and the scanning channels of the radar system may be grouped according to the channel grouping rule.

In practical applications, if the number of scanning channels is larger, the number of scanning channels included in each scanning channel group may be greater; if the number of scanning channels is smaller, the number of scanning channels included in each scanning channel group may be fewer. If the detection accuracy is higher, the number of scanning channel groups may be greater; if the detection accuracy is lower, the number of scanning channel groups may be fewer.

The number of scanning channel groups can be set according to the requirements of different detection areas and detection accuracies. Furthermore, the number of scanning channels in different scanning channel groups can also be divided based on the actual scanning device, such as the structure of the scanning array. The number of scans for different scanning channel groups may be equal or unequal. Specifically, the number of scans for a scanning channel is related to its position within the scanning array and its required detection accuracy. The higher the detection accuracy required for a scanning channel, the greater the number of scans corresponding to that scanning channel, and the more groups that scanning channel is associated with.

In practical applications, a channel grouping rule generation model can be constructed. This model can then be used to generate corresponding channel grouping rules based on the number of scanning channels in the radar system and the detection accuracy requirements.

In practical applications, after obtaining the channel grouping rule corresponding to the radar system, the scanning channels of the radar system can be grouped according to the channel grouping rule.

It should be noted that the aforementioned channel grouping rule specifically defines the rule for allocating each scanning channel to particular scanning channel groups. This channel grouping rule must satisfy the requirement that, after grouping, each scanning channel is allocated to at least two scanning channel groups within one scanning cycle.

In some embodiments, to further reduce crosstalk, when performing channel grouping, the physical interval between scanning channels within the same scanning channel group should be greater than a preset interval.

It should be noted that the aforementioned preset interval can be set according to the actual application scenario. Specifically, the preset interval is greater than or equal to the diameter of the emitted light spot of any channel among any two adjacent channels in the transmission array.

In S11, acquiring echo signals received multiple times by a scanning channel.

In the embodiments of the present application, after the radar system completes scanning within each scanning cycle, the received echo signals are the result of multiple transmissions and receptions for each scanning channel. To identify whether high-reflection crosstalk exists in the echo signals received by each scanning channel, the echo signals received multiple times by the same scanning channel can be extracted from the received echo signals.

By way of example, for the radar system shown in FIG. 6, the echo signals received multiple times by scanning channel 1, the echo signals received multiple times by scanning channel 2, the echo signals received multiple times by scanning channel 3, and the echo signals received multiple times by scanning channel 4 can be acquired respectively.

In S12, superimposing the echo signals received multiple times by the scanning channel to obtain an echo superposition result of the scanning channel.

In the embodiments of the present application, the echo signals received by the radar system are the result of multiple transmissions and receptions for each scanning channel. To identify whether high-reflection crosstalk exists in the echo signals received by each scanning channel, it is necessary to superimpose the multiple echo signals received by the same scanning channel.

In practical applications, the radar system can extract the peak value of each echo signal and the reception time of the corresponding echo. Based on the echo reception time and the peak value of each echo signal, the multiple echoes received by the same scanning channel are superimposed to obtain the superposition result.

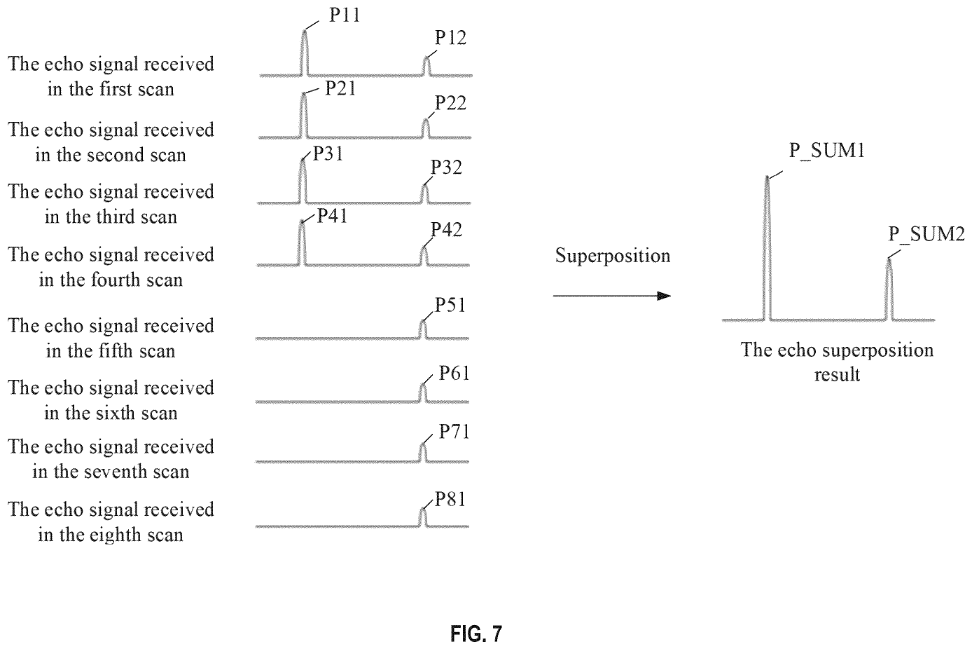

By way of example, taking scanning channel 2 shown in FIG. 6 as an example, assume that scanning channel 1 detects a high-reflectivity object, and the echo signal received by scanning channel 1 is a high-reflection echo. Then, the echo signals received by scanning channel 2 during scanning time instances 1 to 4 will contain high-reflection crosstalk. As shown in FIG. 7, the echo signal of scanning channel 2 can be resolved into a first echo P_SUM1 and a second echo P_SUM2. Here, the first echo P_SUM1 is the echo that includes high-reflection crosstalk, i.e., the four echo signals received during scanning time instances 1 to 4, while the second echo P_SUM2 is the genuine echo of scanning channel 2, with a total of eight genuine echoes present (since scanning channel 2 was scanned eight times). After superimposing the echo signals received by scanning channel 2, the superimposed result shown in FIG. 7 can be obtained.

In S13, performing crosstalk echo identification based on the echo superposition result, and upon identifying the presence of a crosstalk echo, filtering out the crosstalk echo to obtain a valid echo of the scanning channel.

In practical applications, if a scanning channel receives a high-reflection echo, the crosstalk from this channel will not interfere with part of the echo signals received by other scanning channels. Consequently, in the echo superposition result after superimposition, only the superposition result of partial crosstalk signals will be present. The crosstalk echo can then be identified based on spatiotemporal correlation judgment.

In practical applications, the echo characteristic parameters of the multiple echo signals received by the scanning channel and the echo characteristic parameters of the echo superposition result may be extracted. Then, crosstalk echo identification is performed based on the echo characteristic parameters of the multiple echo signals received by the scanning channel and the echo characteristic parameters of the echo superposition result.

In practical applications, the echo characteristic parameters of the multiple echo signals received by the scanning channel may include: the peak value of each echo signal, the reception time of the echo corresponding to the peak value of each echo signal, and the maximum peak value of the multiple echo signals. The echo characteristic parameters of the echo superposition result may include: the peak value of one or more echoes included in the echo superposition result, and the reception time of the echo corresponding to the peak value.

By way of example, as shown in FIG. 7, the echo characteristic parameters of the multiple echo signals received by the scanning channel may include:
the peak value of the first echo P11 of the echo signal received in the first scan, and the reception time of the echo corresponding to the peak value of P11;
the peak value of the second echo P12 of the echo signal received in the first scan, and the reception time of the echo corresponding to the peak value of P12;
the peak value of the first echo P21 of the echo signal received in the second scan, and the reception time of the echo corresponding to the peak value of P21;
the peak value of the second echo P22 of the echo signal received in the second scan, and the reception time of the echo corresponding to the peak value of P22;
the peak value of the first echo P31 of the echo signal received in the third scan, and the reception time of the echo corresponding to the peak value of P31;
the peak value of the second echo P32 of the echo signal received in the third scan, and the reception time of the echo corresponding to the peak value of P32;
the peak value of the first echo P41 of the echo signal received in the fourth scan, and the reception time of the echo corresponding to the peak value of P41;
the peak value of the second echo P42 of the echo signal received in the fourth scan, and the reception time of the echo corresponding to the peak value of P42;
the peak value of the first echo P51 of the echo signal received in the fifth scan, and the reception time of the echo corresponding to the peak value of P51;
the peak value of the first echo P61 of the echo signal received in the sixth scan, and the reception time of the echo corresponding to the peak value of P61;
the peak value of the first echo P71 of the echo signal received in the seventh scan, and the reception time of the echo corresponding to the peak value of P71;
the peak value of the first echo P81 of the echo signal received in the eighth scan, and the reception time of the echo corresponding to the peak value of P81;
the maximum peak value among P11, P21, P31, and P41; and
the maximum peak value among P12, P22, P32, P42, P51, P61, P71, and P81.
The echo characteristic parameters of the echo superposition result may include:

the peak value of the first echo P_SUM1 in the echo superposition result;
the peak value of the second echo P_SUM2 in the echo superposition result;
the reception time of the echo corresponding to the peak value of the first echo P_SUM1; and
the reception time of the echo corresponding to the peak value of the second echo P_SUM2.

In one embodiment, the echo characteristic parameters include the echo peak value and the reception time of the corresponding echo. If the echo superposition result includes multiple echoes and the reception times of these echoes differ, then performing crosstalk echo identification based on the echo characteristic parameters of the multiple echo signals received by the scanning channel and the echo characteristic parameters of the echo superposition result may involve identification according to the number of superpositions of the original echo signals corresponding to the superimposed echo. That is, the reception time of the echo corresponding to each echo in the echo superposition result is obtained. Based on the reception time of the echo, the number of original echo signals corresponding to the superimposed echo is determined—i.e., how many echo signals (the echo signals received by the scanning channel) were superimposed to form this resulting echo. As shown in FIG. 7, the first echo P_SUM1 is formed by the superposition of four echo signals (the first echo P11 of the echo signal received in the first scan, the first echo P21 of the echo signal received in the second scan, the first echo P31 of the echo signal received in the third scan, and the first echo P41 of the echo signal received in the fourth scan). Thus, the number of original echo signals corresponding to the first echo P_SUM1 is 4. The second echo P_SUM2 is formed by the superposition of eight original echo signals (the second echo P12 of the echo signal received in the first scan, the second echo P22 of the echo signal received in the second scan, the second echo P32 of the echo signal received in the third scan, the second echo P42 of the echo signal received in the fourth scan, the first echo P51 of the echo signal received in the fifth scan, the first echo P61 of the echo signal received in the sixth scan, the first echo P71 of the echo signal received in the seventh scan, and the first echo P81 of the echo signal received in the eighth scan). Thus, the number of original echo signals corresponding to the second echo P_SUM2 is 8. If the number of original echo signals is less than the number of activations of the scanning channel, then that echo can be determined to be a crosstalk echo. For example, in FIG. 7, the number of activations of the scanning channel is 8. Since the number of original echo signals for the first echo P_SUM1 is 4, which is less than 8, the first echo P_SUM1 can be identified as a crosstalk echo.

In practical applications, it is also possible to determine whether the echo received by the scanning channel is a genuine echo or a crosstalk echo by comparing the product of the maximum peak value from the multiple received echo signals and a crosstalk coefficient with the peak value of the echo in the echo superposition result.

In an embodiment of the present application, the echo characteristic parameters of the multiple echo signals received by the scanning channel include a maximum peak value of the multiple echo signals of the scanning channel. If the echo superposition result includes multiple echoes and there is a difference in the reception times of said multiple echoes, then the echo characteristic parameters of the echo superposition result include the peak value and the corresponding reception time of each echo in the echo superposition result. Said performing crosstalk echo identification based on the echo characteristic parameters of the multiple echo signals received by the scanning channel and the echo characteristic parameters of the echo superposition result includes:
determining a target maximum peak value corresponding to each echo based on the reception times of the multiple echoes in the echo superposition result;
calculating a crosstalk threshold corresponding to the echo based on the target maximum peak value; and
if the peak value of an echo is less than the crosstalk threshold corresponding to said echo, determining that said echo is a crosstalk echo.

In practical applications, calculating the crosstalk threshold based on the maximum peak value of the multiple received echo signals may involve multiplying the maximum peak value of the multiple received echo signals by a crosstalk coefficient.

In the embodiments of the present application, the setting of the aforementioned crosstalk coefficient can be configured according to practical application requirements, and this crosstalk coefficient is greater than the superposition count of the crosstalk echo and less than the superposition count of the genuine echo. For example, regarding the scanning channel grouping scenario illustrated in FIG. 6, the superposition count of the crosstalk echo is 4, and the superposition count of the genuine echo is 8. In this case, the crosstalk coefficient can be set to 5.

Since the maximum peak value of the multiple received echo signals is selected to calculate the crosstalk threshold, multiplying this maximum peak value by the crosstalk coefficient results in a crosstalk threshold that will be greater than the superposition result of the crosstalk signals. Meanwhile, the superposition count of the genuine signal is greater than that of the crosstalk signal. Therefore, by comparing the peak value of the superimposed echo with the crosstalk threshold, it can be determined whether the peak value of the superimposed echo is less than this crosstalk threshold. If it is, the superimposed echo can be identified as a crosstalk echo; if not, it can be identified as a genuine echo.

By way of example, as shown in FIG. 7, assume the superposition result includes a first echo P_SUM1 and a second echo P_SUM2. For the first echo P_SUM1, the maximum peak value is selected from the four superimposed echo signals, for example, denoted as peak1. For the second echo P_SUM2, the maximum peak value selected from the eight superimposed echo signals is denoted as peak2. Assume the peak value of the first echo P_SUM1 after superposition is accu_peak1, and the peak value of the second echo P_SUM 2 after superposition is accu_peak2. Assuming the crosstalk coefficient is 5, then:
calculate peak1*5 and determine whether accu_peak1 is less than peak1*5, if yes, the first echo P_SUM1 can be identified as a crosstalk echo; and
calculate peak2*5 and determine whether accu_peak2 is less than peak2*5, if not, the second echo P_SUM2 can be identified as a genuine echo.

In an embodiment of the present application, the aforementioned echo signal processing method may further include the following step: when a crosstalk echo is identified, labeling the crosstalk echo.

In practical applications, the aforementioned marking of the crosstalk echo may specifically involve setting an echo label, so that subsequent processing modules can identify the crosstalk echo.

In practical applications, after the radar system determines that a superimposed echo is a crosstalk echo, it can filter out the crosstalk echo to obtain the valid echo of the scanning channel. This reduces the impact of crosstalk echoes on the radar measurement results and improves the measurement accuracy of the radar.

In S14, performing target identification based on the valid echoes from all scanning channels.

In practical applications, after the radar system filters out the crosstalk echoes identified in each scanning channel, it can perform target identification based on the valid echoes from all scanning channels, thereby meeting the requirement for target detection in the environment.

As can be seen from the above, the echo signal processing method provided by the embodiments of the present application can disperse the high-reflection crosstalk from a high-reflection channel among different scanning channels, so that only part of the echoes in the affected scanning channel are subject to crosstalk. Therefore, crosstalk echoes can be identified based on the superposition result after overlapping, and subsequently, the crosstalk echoes can be filtered out. This reduces the impact of high-reflection crosstalk on radar measurement results, thereby improving the measurement accuracy of the radar. Moreover, it does not require configuring more scanning channel groups or enhancing the processing capability or bandwidth of the radar system's processing chip.

It should be understood that the order of the steps in the foregoing embodiments does not imply a sequence of execution. The execution sequence of each process should be determined by its function and internal logic, and should not constitute any limitation on the implementation process of the embodiments of the present application.

Based on the echo signal processing method provided in the foregoing embodiments, embodiments of the present invention further provide an embodiment of an echo data processing apparatus for implementing the aforementioned method embodiments.

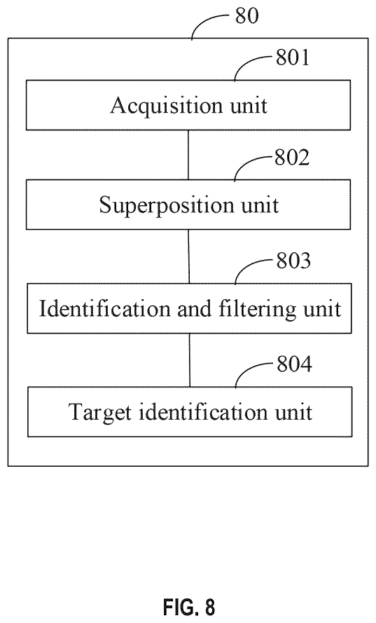

Please refer to FIG. 8, which is a schematic structural diagram of an echo data processing apparatus provided by an embodiment of the present application. In this embodiment of the present application, the echo data processing apparatus is applied to a radar system. The radar system includes at least two scanning channels, and any one scanning channel is allocated to at least two scanning channel groups within one scanning cycle. The various units included in the echo data processing apparatus are configured to perform the steps in the embodiment corresponding to FIG. 4. For details, please refer to the related descriptions in FIG. 4 and the corresponding embodiment. For ease of explanation, only the parts relevant to this embodiment are shown. As illustrated in FIG. 8, the echo data processing apparatus 80 may include an acquisition unit 801, a superposition unit 802, an identification and filtering unit 803, and a target identification unit 804, where:
the acquisition unit 801 is configured to acquire echo signals received multiple times by a scanning channel;
the superposition unit 802 is configured to superimpose the echo signals received multiple times by the scanning channel to obtain an echo superposition result of the scanning channel;
the identification and filtering unit 803 is configured to perform crosstalk echo identification based on the echo superposition result and, upon identifying the presence of a crosstalk echo, filter out the crosstalk echo to obtain a valid echo of the scanning channel; and
the target identification unit 804 is configured to perform target identification based on the valid echoes from all scanning channels.

In some implementations, the identification and filtering unit 803 is specifically configured to:
extract echo characteristic parameters of the multiple echo signals received by the scanning channel and echo characteristic parameters of the echo superposition result; and
perform crosstalk echo identification based on the echo characteristic parameters of the multiple echo signals received by the scanning channel and the echo characteristic parameters of the echo superposition result.

In some implementations, the echo characteristic parameters include an echo peak value and a reception time of a corresponding echo. If the echo superposition result includes multiple echoes and reception times of the multiple echoes differ, the identification and filtering unit 803 is specifically configured to:
determine a number of original echo signals corresponding to each echo in the echo superposition result based on the echo peak values and reception times of the corresponding echoes of the echo signals received by the scanning channel, and the echo peak values and reception times of the corresponding echoes of each echo in the echo superposition result; and
if the number of original echo signals corresponding to an echo in the echo superposition result is less than an activation count of the scanning channel, determine that the echo is a crosstalk echo.

In some implementations, the echo characteristic parameters of the multiple echo signals received by the scanning channel include a maximum peak value of the multiple echo signals of the scanning channel. If the echo superposition result includes multiple echoes and there is a difference in the reception times of said multiple echoes, then the echo characteristic parameters of the echo superposition result include the peak value and the corresponding reception time of each echo in the echo superposition result. The identification and filtering unit 803 is specifically configured to:
determine a target maximum peak value corresponding to each echo based on the reception times of the multiple echoes in the echo superposition result;
calculate a crosstalk threshold corresponding to the echo based on the target maximum peak value; and
if the peak value of an echo is less than the crosstalk threshold corresponding to said echo, determine that said echo is a crosstalk echo.

In some implementations, the echo data processing apparatus further includes a generation unit and a grouping unit. The generation unit is configured to generate a channel grouping rule based on the number of scanning channels and a detection accuracy of the radar system. The grouping unit is configured to group the scanning channels of the radar system according to the channel grouping rule.

It should be noted that the information interaction and execution processes between the aforementioned units, being based on the same concept as the method embodiments of the present application, and their specific functions and technical effects can be referred to the description in the method embodiments section, and thus are not reiterated here.

Therefore, the echo data processing apparatus provided by the embodiments of the present application can disperse the high-reflection crosstalk from a high-reflection channel among different scanning channels, so that only part of the echoes in the affected scanning channel are subject to crosstalk. Consequently, crosstalk echoes can be identified based on the superposition result after overlapping, and the crosstalk echoes can then be filtered out. This reduces the impact of high-reflection crosstalk on radar measurement results, thereby improving the measurement accuracy of the radar. Moreover, it does not require configuring more scanning channel groups or enhancing the processing capability or bandwidth of the radar system's processing chip.

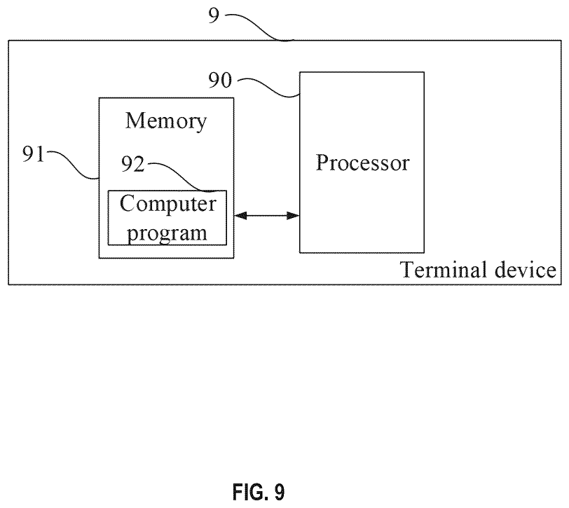

FIG. 9 is a schematic structural diagram of a terminal device provided by an embodiment of the present application. As shown in FIG. 9, the terminal device 9 provided in this embodiment includes: a processor 90, a memory 91, and a computer program 92 stored in the memory 91 and executable on the processor 90, such as an echo signal processing program. When the processor 90 executes the computer program 92, it implements the steps in the various echo signal processing method embodiments described above, for example, steps S11 to S14 shown in FIG. 4. Alternatively, when the processor 90 executes the computer program 92, it implements the functions of the various modules/units in the terminal device embodiments described above, for example, the functions of units 801 to 804 shown in FIG. 8.

By way of example, the aforementioned computer program 92 may be divided into one or more modules/units. The one or more modules/units are stored in the memory 91 and executed by the processor 90 to implement the present application. The one or more modules/units may be a series of computer program instruction segments capable of performing specific functions. These instruction segments are used to describe the execution process of the computer program 92 in the terminal device 9. For instance, the computer program 92 may be divided into an acquisition unit, a determination unit, and a calculation unit. For the specific functions of each unit, please refer to the relevant descriptions in the embodiment corresponding to FIG. 9, which are not repeated here.

The aforementioned terminal device may include, but is not limited to, the processor 90 and the memory 91. Those skilled in the art will understand that FIG. 9 is merely an example of the terminal device 9 and does not limit the terminal device 9, which may include more or fewer components than those illustrated, or a combination of certain components, or different components. For example, the terminal device may further include input/output devices, network access devices, buses, and the like.

The aforementioned processor 90 may be a Central Processing Unit (CPU), or it may be another general-purpose processor, a Digital Signal Processor (DSP), an Application Specific Integrated Circuit (ASIC), a Field-Programmable Gate Array (FPGA), or other programmable logic device, discrete gate or transistor logic device, discrete hardware component, etc. A general-purpose processor may be a microprocessor, or the processor may be any conventional processor or the like.

The aforementioned memory 91 may be an internal storage unit of the terminal device 9, such as a hard disk or memory of the terminal device 9. The memory 91 may also be an external storage device of the terminal device 9, such as a plug-in hard disk, a Smart Media Card (SMC), a Secure Digital (SD) card, a Flash Card, etc., equipped on the terminal device 9. Furthermore, the memory 91 may further include both the internal storage unit and an external storage device of the terminal device 9. The memory 91 is used to store the computer program and other programs and data required by the terminal device. The memory 91 may also be used to temporarily store data that has been output or is to be output.

An embodiment of the present application further provides a computer-readable storage medium. The computer-readable storage medium stores a computer program which, when executed by a processor, causes the processor to implement the echo signal processing method described above.

An embodiment of the present application provides a computer program product. When the computer program product is run on a terminal device, it causes the terminal device to execute and implement the echo signal processing method described above.

Those skilled in the art may clearly understand that, for the convenience and brevity of description, only the division of the aforementioned functional units and modules is used as an example for illustration. In practical applications, the aforementioned functions may be allocated to be completed by different functional units or modules as needed. That is, the internal structure of the terminal device is divided into different functional units or modules to complete all or part of the functions described above. The functional units and modules in the embodiments may be integrated into one processing unit, or each unit may exist physically alone, or two or more units may be integrated into one unit. The integrated unit may be implemented in the form of hardware or a software functional unit. In addition, the specific names of the functional units and modules are only for the convenience of distinguishing them from each other and are not intended to limit the scope of protection of the present application. For the specific working processes of the units and modules in the aforementioned system, reference may be made to the corresponding processes in the foregoing method embodiments, which are not repeated here.

In the foregoing embodiments, the description of each embodiment has its own focus. For parts not described in detail or recorded in a certain embodiment, reference may be made to the relevant descriptions in other embodiments.

Those of ordinary skill in the art may appreciate that the units and algorithm steps of the examples described in combination with the embodiments disclosed herein can be implemented by electronic hardware, or a combination of computer software and electronic hardware. Whether these functions are performed by hardware or software depends on the specific application and design constraints of the technical solution. Professionals and technicians can use different methods for each specific application to implement the described functions, but such implementation should not be considered beyond the scope of the present application.

What is claimed is:

1. An echo signal processing method, applied to a radar system, the radar system comprising at least two scanning channels, wherein any one scanning channel is allocated to at least two scanning channel groups within one scanning cycle, the method comprising:
acquiring echo signals received multiple times by a scanning channel;
superimposing the echo signals received multiple times by the scanning channel to obtain an echo superposition result of the scanning channel;
performing crosstalk echo identification based on the echo superposition result, and upon identifying presence of a crosstalk echo, filtering out the crosstalk echo to obtain a valid echo of the scanning channel; and
performing target identification based on the valid echoes from all scanning channels.

2. The echo signal processing method according to claim 1, wherein the performing the crosstalk echo identification based on the echo superposition result comprises:
extracting echo characteristic parameters of the echo signals received by the scanning channel and echo characteristic parameters of the echo superposition result; and
performing crosstalk echo identification based on the echo characteristic parameters of the echo signals received by the scanning channel and the echo characteristic parameters of the echo superposition result.

3. The echo signal processing method according to claim 2, wherein:
the echo characteristic parameters comprise an echo peak value and a corresponding reception time of the echo;
in response to the echo superposition result comprising multiple echoes and a difference existing in the reception times of the multiple echoes, then the performing the crosstalk echo identification based on the echo characteristic parameters of the echo signals received by the scanning channel and the echo characteristic parameters of the echo superposition result comprises:
determining, based on the echo peak values and the corresponding reception times of respective echoes of the echo signals received by the scanning channel, and the echo peak values and the corresponding reception times of respective echoes in the echo superposition result, a number of original echo signals corresponding to each echo in the echo superposition result; and
in response the number of original echo signals corresponding to an echo in the echo superposition result being less than a number of activations of the scanning channel, determining that the echo is a crosstalk echo.

4. The echo signal processing method according to claim 2, wherein:
the echo characteristic parameters of the echo signals received by the scanning channel comprise a maximum peak value of the multiple echo signals of the scanning channel;
in response to the echo superposition result comprising multiple echoes and a difference existing in reception times of the multiple echoes, then the echo characteristic parameters of the echo superposition result comprise the peak value and the corresponding reception time of each echo in the echo superposition result;
the performing the crosstalk echo identification based on the echo characteristic parameters of the multiple echo signals received by the scanning channel and the echo characteristic parameters of the echo superposition result comprises:
determining a target maximum peak value corresponding to each echo based on the reception times of the multiple echoes in the echo superposition result;
calculating a crosstalk threshold corresponding to the echo based on the target maximum peak value; and
in response to the peak value of an echo being less than the crosstalk threshold corresponding to the echo, determining that the echo is a crosstalk echo.

5. The echo signal processing method according to claim 1, wherein before the acquiring echo signals received multiple times by the scanning channel, the method further comprises:
generating a channel grouping rule based on a number of scanning channels and a detection accuracy of the radar system; and
grouping the scanning channels of the radar system according to the channel grouping rule.

6. The echo signal processing method according to claim 5, wherein the number of scans for different scanning channel groups is equal or unequal.

7. The echo signal processing method according to claim 6, wherein a physical interval between scanning channels within one scanning channel group is greater than a preset interval.

8. An echo data processing apparatus, applied to a radar system, the radar system comprising at least two scanning channels, wherein any one scanning channel is allocated to at least two scanning channel groups within a scanning cycle, the apparatus comprising:
an acquisition unit, configured to acquire echo signals received multiple times by the scanning channel;
a superposition unit, configured to superimpose the echo signals received multiple times by the scanning channel to obtain an echo superposition result of the scanning channel;
an identification and filtering unit, configured to perform crosstalk echo identification based on the echo superposition result, and upon identifying presence of a crosstalk echo, filter out the crosstalk echo to obtain a valid echo of the scanning channel; and
a target identification unit, configured to perform target identification based on the valid echoes from all scanning channels.

9. A terminal device, comprising a memory, a processor, and a computer program stored in the memory and executable on the processor, wherein, when the processor executes readable instructions of the computer program, the processor implements the echo signal processing method according to claim 1.
